(19) United States
(12) Patent Application Publication
(10) Pub. No.: US 2012/0206782 A1
(43) Pub. Date: Aug. 16, 2012

(54) DEVICE FOR REDUCING SPECKLE EFFECT IN A DISPLAY SYSTEM

(75) Inventors: Yick Chuen CHAN, Hong Kong (HK); Siu Wai Lam, Hong Kong (HK); Yao Jun FENG, Shenzhen (CN); Francis Chee-Shuen LEE, Hong Kong (HK); Ho Yin CHAN, Hong Kong (HK)

(73) Assignee: Hong Kong Applied Science and Technology Research Institute Company Limited, Hong Kong (HK)

(21) Appl. No.: 13/029,111

(22) Filed: Feb. 16, 2011

(51) Int. Cl. G02B 26/10; G02B 27/48

(52) U.S. Cl. 359/199.2; 359/199.4; 359/199.3

(57) ABSTRACT

The present invention relates to a method and apparatus for speckle noise reduction in laser scanning display. In particular, a MEMS device which can superpose vibrational motion onto a biaxial scanning mirror is provided for reducing the effect of speckling.

### CROSS REFERENCE TO RELATED PATENT APPLICATION

All the subject matter of the co-pending U.S. patent application entitled “Device for Reducing Speckle Effect in a Display System” filed under the attorney docket number P3449US00 on 16 Feb. 2011 and the entire content thereof is hereby incorporated by reference.

### TECHNICAL FIELD

The present application relates to an apparatus for projecting a digital image in general and, more particularly, to de-speckling devices and methods that can reduce or remove speckle in an image formed by a laser-based projector.

### BACKGROUND

We receive visual information all the time, for example, watching movies. Nowadays, a huge amount of visual information is generated because of the user-friendliness of consumer electronics such as digital cameras. Similarly, there is a huge demand for displays from which we receive visual information. The development of display technology has been fast and the number of different ways to display an image has been increasing, for example, cathode ray tube (CRT) displays, liquid crystal device (LCD) displays, light emitting diode (LED) displays, organic LED (OLED) displays, head-up displays (HUD), laser scanning projection (LSP) displays, and projectors. In the present description, whenever a reference is made to an image, the same will also be applicable to a motion picture which is also known as video.

Human vision is sensitive to noise so that a good image quality without noise is very much appreciated. One type of noise is known to be speckles and this sort of speckle noise is particularly common for displays with a coherent light source such as a laser in a display, such as a HUD or a LSP display. For example, in the case of a projector with a laser as the light source, there will be speckles in the image projected onto a screen due to the laser being reflected by a screen surface as depicted in FIG. 1. When compared with the wavelengths of visible light, the surface of any screen can be regarded as rough and therefore gives rise to scattering. The reflected light rays reaching a viewer's eyes from various independent scattering areas on the screen surface have relative phase differences and interfere with one anther, generating granular bright and dark patterns called speckle.

Numerous approaches have been adopted to reduce the speckle by destroying the coherence of the laser beam. If the coherence of the laser beam is destroyed, the speckle can be averaged out because the speckle effects become independent. For N independent speckle patterns, the reduction factor is given by the following equation (1):

R=\sqrt{N} (1)

These approaches include providing angular diversity, wavelength diversity, polarization diversity or screen-based solutions. As discussed by Joseph W. Goodman in “Speckle phenomena in optics: theory and applications”, Englewood, Colo.: Roberts & Co., ©2007, attempts have been previously made to provide various solutions on de-speckling. Some approaches have become conventional practices in the industry, for example:

(1) using several lasers as the illumination light source;

(2) illuminating the light source from different angles;

(3) introducing wavelength diversity in the illumination;

(4) using different polarization states of laser;

(5) using a screen specially designed to minimize the generation of speckle, for example, a moving screen; and

(6) using a rotating diffuser.

Theses proposed solutions for speckle reduction have various strengths and weaknesses. Some requires an addition component like a diffuser to be provided in the system and may make it even more challenging in miniaturizing the systems, for example, a diffuser directing the diffused laser light to a rocking mirror for speckle reduction as described in the U.S. Pat. No. 4,155,630 titled “Speckle Elimination By Random Spatial Phase Modulation”, or a spinning diffuser as described in the U.S. Pat. No. 5,313,479 titled “Speckle-free Display System using Coherent Light”.

Use of additional components may further contribute to difficulties in integrating the speckle reduction scheme into existing systems, while some even require external moving actuators which lead to additional power consumption. For example, the European Patent Application EP1,949,166 describes the use of actuator pads to drive an Al-coated micromachined membrane in the direction towards these actuator pads; the Al-coated micromachined membrane deforms a mirror which scatters light to reduce speckle. Such an actuation mechanism also confines the mirror deformation along one single direction.

Some proposed solutions require a moving screen which not only makes image display impossible on any still screen but also may become problematic to find an appropriate means to move the screen as the screen size increases. For example, it will be difficult for the transducer described in U.S. Pat. No. 5,272,473 entitled “Reduced-Speckle Display System” to work for a large screen where the transducer is required to be coupled to a display screen to set up surface acoustic waves which traverse the display screen. There is another type of moving display described in U.S. Pat. No. 6,122,023 entitled “Non-speckle Liquid Crystal Projection Display” which provides a layer of liquid crystal molecules vibrating slightly at a frequency higher than 60 Hz in the display screen.

There remains a need in the art to provide speckle reduction for displays.

### SUMMARY OF THE INVENTION

An object of the present invention is to provide a mirror and an illumination light source capable of effectively suppressing speckle noise using a simple optical system. The present invention provides a MEMS (microelectromechanical system) device which has a movable plate attached to a stationary frame. The movable plate has a region with features capable of scattering incident laser beams.

During operation, the movable plate vibrates in various directions and the vibration causes incident laser beams periodically hitting the plate at different incident angles and consequently these laser beams are reflected from the movable plate with distinct reflection angles temporally. These temporally incoherent reflected laser beams can then be utilized as a light source with suppressed laser speckle effect.

The MEMS device provided by the present invention can be manufactured in a batch fabrication process which lowers the device unit cost. The MEMS fabrication technology results in a small device form factor which is highly desirable in many portable consumer electronic products.

Furthermore, high optical efficiency can be achieved by using the MEMS device according to the present invention which works without any diffuser and the reflective surface profiles provided by the MEMS device of the present invention are more controllable.

Since no external moving actuator or diffuser is needed, the present invention has low power consumption.

The MEMS device according to the present invention allows a controllable vibration amplitude or frequency so that parameter tuning can be performed to attain an optimized laser de-speckle effect. The vibration amplitude is adjusted by, for example, varying input driving voltage to the MEMS device while the vibration frequency is tuned by designing the dimensions of the actuating parts of the MEMS device, for example, by changing torsional bar dimensions. The present invention provides a robust structure with a similar process flow to the MEMS scanning mirror fabrication, enabling further integration of the de-speckle device into the MEMS scanning mirror.

One aspect of the present invention is to provide a MEMS device for reducing speckle effect in a laser scanning projection display, which includes a movable plate rotatable along a first axis of rotation and further rotatable along a second axis of rotation, the first axis of rotation being substantially perpendicular to the second axis of rotation; one or more first actuators for moving the movable plate along at least a first direction; and one or more second actuators for moving the movable plate along at least a second direction. The first actuators and the second actuators are capable of moving the movable plate such that a combination of vertical, transverse and rotational motions of the movable plate reflecting a laser beam at distinct angles are possible using different regions of the movable plate temporally. The combination of motions in different directions makes the incident laser beam strikes on the scanning mirror at different angles forming a substantially circular locus of incident points.

An embodiment of an actuator is an electrostatic comb, a magnetic actuator, and a piezoelectric actuator.

Another aspect of the present invention is to fabricate a biaxial scanning mirror rotatable along two substantially perpendicular axes on top of the movable plate.

According to a further aspect, the biaxial scanning mirror on the top of the movable plate is coated with a scattering layer and the surface of the scattering layer is coated with a reflective coating. Alternatively, the surface of the scattering layer is roughened, is a patterned film of dielectric, or has a polymeric structure on its surface.

Another aspect of the present invention is to provide a reflective coating between the top of the biaxial scanning mirror and the scattering layer. In this case, the scattering layer is made of an inhomogeneous phase-changing polymer.

One aspect of the present invention is to provide an optical system using the MEMS device with movable plate as described above, which includes an illumination source emitting one or more laser beams, the one or more laser beams being transmitted onto the movable plate of the MEMS device and reflected thereby; and a biaxial MEMS mirror receiving the laser beams reflected from the MEMS devices and reflecting the laser beams in a scanning manner to generate an image on a screen.

Another aspect of the present invention is to provide an optical system using the MEMS device with movable plate as described above, which includes an illumination source emitting one or more laser beams, the one or more laser beams being transmitted onto the movable plate of the MEMS device and reflected thereby; at least one additional MEMS device(s) being arranged to receive and reflect the laser beams reflected from the MEMS device; and a biaxial MEMS mirror receiving the laser beams reflected from the additional MEMS device(s) and reflecting the laser beams in a scanning manner to generate an image on a screen.

A further aspect of the present invention is to provide an optical system using the MEMS device with movable plate as described above wherein the movable plate has its top fabricated with a biaxial MEMS mirror, which includes an illumination source emitting one or more laser beams, the one or more laser beams being transmitted onto the movable plate of the MEMS device and reflected thereby; and at least one additional MEMS device(s) being arranged to use the biaxial MEMS mirror to receive and reflect the reflected laser beams from the MEMS device in a scanning manner to generate an image on a screen.

A further aspect of the present invention is to provide an optical system using the MEMS device with movable plate as described above wherein the movable plate has its top fabricated with a biaxial MEMS mirror, which includes an illumination source emitting one or more laser beams, one or more laser beams being transmitted onto the biaxial MEMS mirror of the MEMS device and reflected thereby in a scanning manner to generate an image on a screen.

Other aspects of the present invention are also disclosed as illustrated by the following embodiments.

### BRIEF DESCRIPTION OF THE DRAWINGS

These and other objects, aspects and embodiments of this claimed invention will be described hereinafter in more details with reference to the following drawings, in which:

FIG. 1 depicts the scattering of a laser beam on a surface.

FIG. 2 depicts a movable plate capable of rotational motion according to one embodiment of the present invention.

FIG. 3 depicts a movable plate with combs along one or more of its edges according to one embodiment of the present invention.

FIG. 4a depicts a vertical vibration of a movable plate according to one embodiment of the present invention.

FIG. 4b depicts a transverse vibration of a movable plate according to one embodiment of the present invention.

FIG. 4c depicts a rotational vibration of a movable plate according to one embodiment of the present invention.

FIG. 4d depicts a triangular movable plate according to one embodiment of the present invention.

FIG. 4e depicts an enlarged illustration of the comb structures of the triangular movable plate according to one embodiment of the present invention.

FIG. 4f depicts a laser projection by the triangular movable plate according to one embodiment of the present invention.

FIG. 5a depicts a roughened scattering layer on top of a movable plate according to one embodiment of the present invention.

FIG. 5b depicts a patterned scattering layer on top of a movable plate according to one embodiment of the present invention.

FIG. 5c depicts a scattering layer of inhomogeneous materials on top of a movable plate according to one embodiment of the present invention.

FIG. 5d depicts a scattering layer of polymeric structures on top of a movable plate according to one embodiment of the present invention.

FIG. 6 depicts an illustration of the effect of de-speckling by one embodiment of the present invention.

FIG. 7a depicts a schematic block diagram of an optical system using a movable plate with biaxial MEMS device according to one embodiment of the present invention.

FIG. 7b depicts a schematic block diagram of an optical system using one or more movable plates according to one embodiment of the present invention.

FIG. 7c depicts a schematic block diagram of an optical system using one or more movable plates and an independent biaxial MEMS mirror according to one embodiment of the present invention.

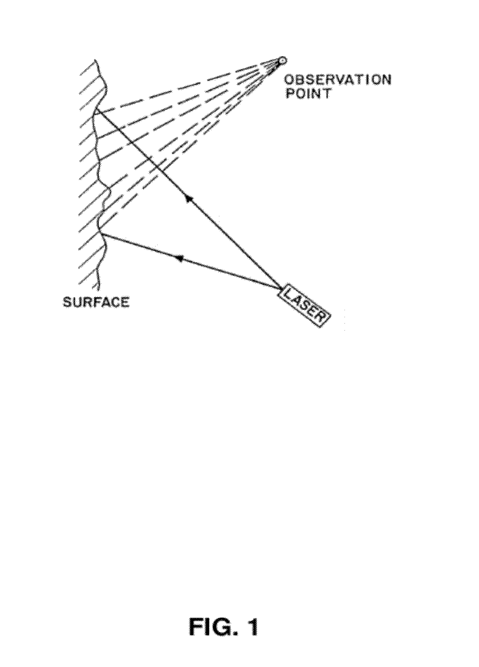

### DETAILED DESCRIPTION OF THE INVENTION

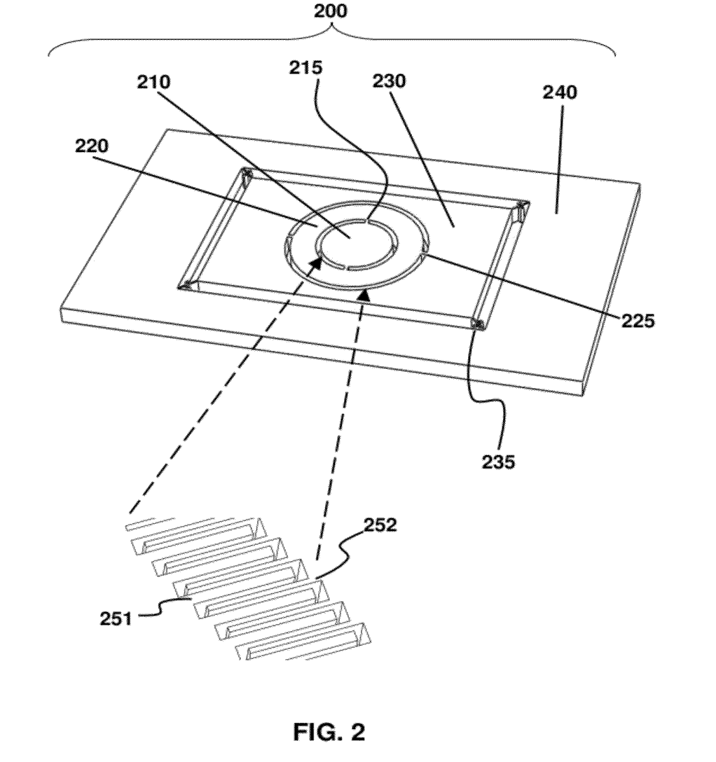

FIG. 2 depicts a laser de-speckle device 200 according to one embodiment of the present invention. The de-speckle device 200 includes movable plate 230 supported by supporting frame 240 via supporting springs 235. The supporting springs 235 can also be implemented as a torsional bar. Such torsional bars or supporting springs are designed with various dimensions to fit the oscillating frequency of the movable plate 230. Movable plate 230 is capable of vibrational motion in the plane of the movable plate and also in the direction perpendicular to the plane of the plate. The vibrational motion of movable plate 230 is periodic; thus light incident on any device supported by the movable plate will strike at different incident angles of the device according to the time of incidence. Consequently, an incident laser beam(s) will be reflected and/or scattered from a device supported by the movable plate with temporally varied properties, reducing the coherence. The reflected laser beam(s) form an illumination source with reduced laser speckle effect.

For reduced laser speckle applications that also require laser scanning (e.g., displays, projectors), the laser de-speckle device can include a scanning device positioned in the vibrating movable plate 230. In this manner, a single, small form factor element provides both scanning and de-speckling.

In the embodiment of FIG. 2, a movable plate 230 has a biaxial MEMS mirror (also known as two-axis (2D) MEMS mirror) integrally fabricated therein. In this exemplary embodiment, the biaxial MEMS mirror is used; however, any mirror can be used in the movable plate of the present invention. Since the biaxial MEMS mirror performs scanning while movable plate 230 vibrates, the device of FIG. 2 provides a scanned beam having reduced coherence. The biaxial MEMS mirror includes central mirror 210 and surrounding gimbal 220. Movable plate 230 thus becomes the frame for supporting gimbal 220. The mirror 210 rotates along the mirror axis through a pair of torsional bars 215. The gimbal 220 rotates along the gimbal axis through a pair of torsional bars 225. The mirror 210 and the gimbal 220 are circular in shape respectively. The gimbal axis and the mirror axis are more or less perpendicular to each other. Rotor combs 252 are fabricated along the outer edges of both the mirror 210 and the gimbal 220. Stator combs 251 are fabricated along the inner edges of both the gimbal 220 and the frame 230. Stator combs 251 and rotor combs 252 are vertical electrostatic combs.

The rotation of the mirror 210 is actuated by the vertical electrostatic combs and the rotation along the mirror axis is denoted as x-direction rotation. The rotation of the gimbal 220 is actuated by vertical electrostatic combs and the rotation along the gimbal axis is denoted as y-direction rotation. The mirror axis is arranged on the plane of gimbal such that the mirror axis follows the rotation of the gimbals. This enables the out-of-plane rotation of the mirror 210 both in x- and y-directions by a gimbal structure.

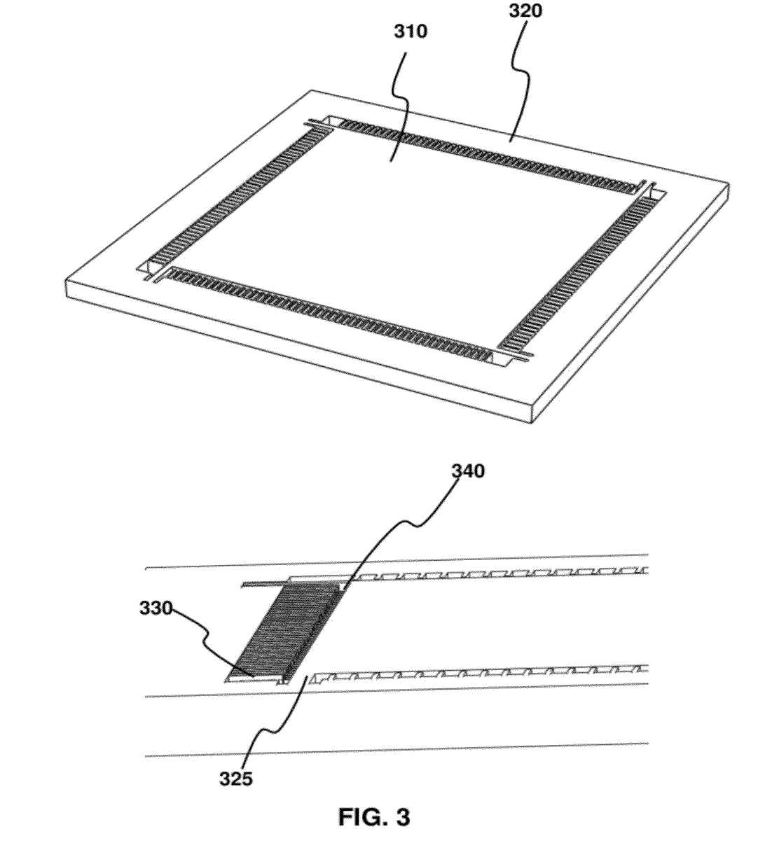

In one embodiment, the movable plate 230 has a rectangular shape. The four corners of the movable plate are connected to the supporting frame 240 by the supporting springs 235. In another embodiment, the rectangular movable plate, designated by reference numeral 310, has one or more of its outer edges fabricated with actuators exemplarily depicted as moving combs 340 as depicted in FIG. 3. The supporting frame 320 has one or more of its inner edges fabricated with actuators exemplarily depicted as stationary combs 330. The movable plate 310 is supported by the supporting frame 320 through a plurality of supporting bars 325.

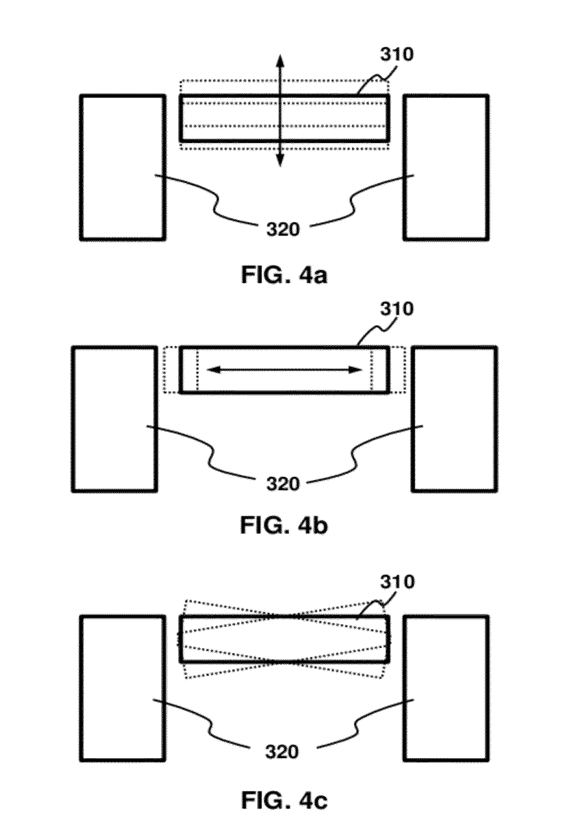

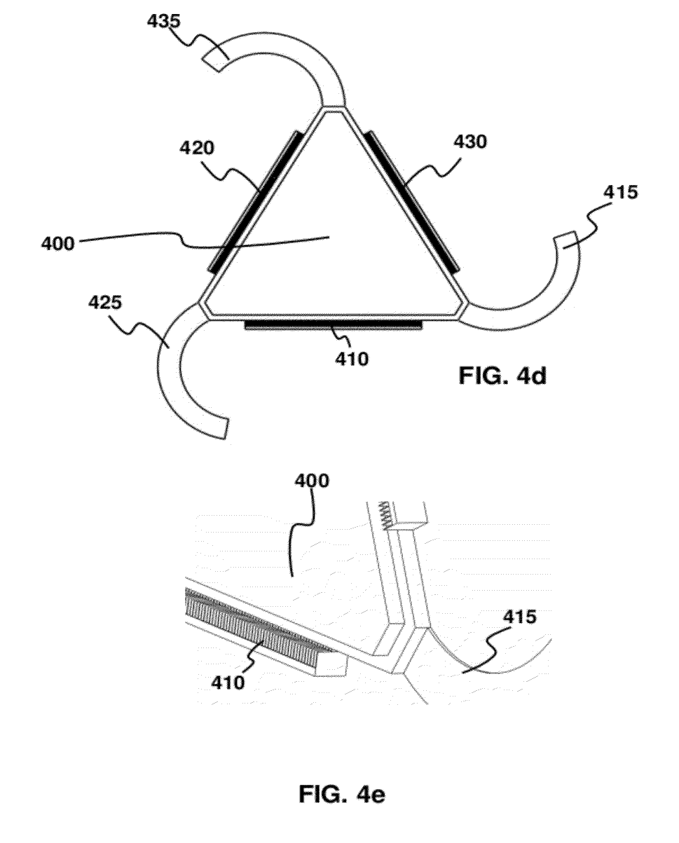

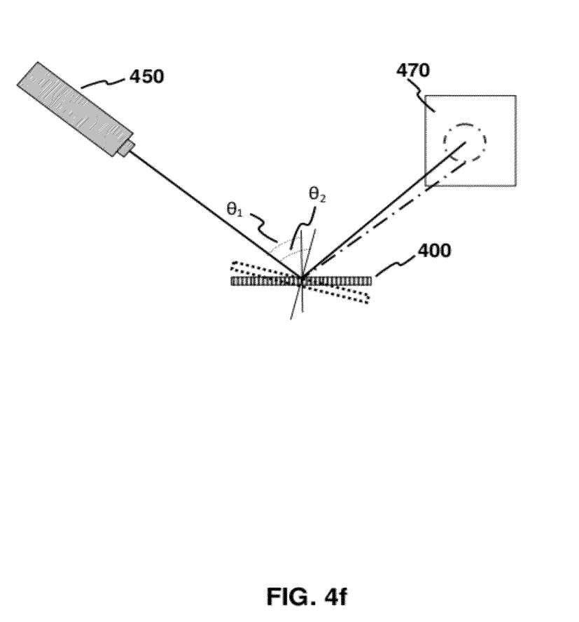

The electrostatic interaction between the stationary combs 330 and the moving combs 340 provides the movable plate 310 with vertical vibration relative to the supporting frame 320 as depicted in FIG. 4a. The electrostatic interaction between the stationary combs 330 and the moving combs 340 also provides the movable plate 310 with transverse vibration relative to the supporting frame 320 as depicted in FIG. 4b. The electrostatic interaction between the stationary combs 330 and the moving combs 340 further provides the movable plate 310 with rotational vibration relative to the supporting frame 320 as depicted in FIG. 4c. The stationary combs 330 and its corresponding moving combs 340 are regarded as one comb assembly.

Each type of vibration can be generated by a comb assembly at one side of the movable plate 310 together with another comb assembly at the opposite side of the movable plate 310. These two comb assemblies at the opposite sides of the movable plate 310 constitute a set of comb assemblies. The rectangular movable plate 310 has two sets of comb assemblies with one arranged in an orientation orthogonal to the other. Consequently, the two sets of comb assemblies can provide the movable plate 310 with transverse motions in two directions with one orthogonal to another. In other words, if the four sides of the movable plate 310 is labeled sequentially as first, second, third and fourth sides, the moving combs on the first and third sides provide a transverse motion in one direction while the moving combs on the second and fourth sides provide a transverse motion in an orthogonal direction. The two transverse motions along orthogonal directions may be independent of each other.

Similarly, for rotational vibration, the two sets of comb assemblies can provide the movable plate 310 with rotation motions along two axes with one orthogonal to another. In other words, if the four sides of the movable plate 310 is labeled sequentially as first, second, third and fourth sides, the moving combs on the first and third sides provide a rotation along one direction while the moving combs on the second and fourth sides provide a rotation along an orthogonal direction. The two rotations along orthogonal directions may be independent of each other. The electrostatic actuation can be replaced or assisted by other types of actuation in other embodiments, for example, magnetic actuation or piezoelectric actuation.

The movable plate has a regular shape. In another embodiment, the shape of the movable plate 310 can be irregular. In addition to the rectangular shape as described above, any polygonal shape can be used for the movable plate 310. For example, in FIG. 4d, the shape of the movable plate 310 is a triangle.

There is a torsional arm 415, 425 and 435 extending from each angle of the triangular movable plate 400. Each side of the triangle movable plate 400 has a comb structure 410, 420 and 430. Actuators as exemplarily depicted as comb structure 410 is enlarged for viewing in FIG. 4e. The shape and the dimensions of the torsional bar are designed in a way to adjust the vibration frequency of the triangular movable plate 400 in optimizing the de-speckling performance. The arrangement, the shape and the dimensions of the teeth of each comb structure are also designed in a way to adjust the vibration frequency of the triangular movable plate 400 in optimizing the de-speckling performance Various parameters can be varied regarding the comb structure, for example, the quantity of the teeth, the length of the teeth, and the width of the teeth and the gap between the teeth.

A plurality of actuators which are depicted exemplarily as combs are arranged around the boundary of the triangular movable plate 400. Along a first side of the triangular movable plate 400, the comb structure 410 is driven by a driving signal V₁. Along a second side of the triangular movable plate 400, the comb structure 420 is driven by a driving signal V₂. Along a third side of the triangular movable plate 400, the comb structure 430 is driven by a driving signal V₃. The driving signals V₁, V₂ and V₃ have a phase difference between one another. The triangle movable plate 400 is driven is a way that the triangular movable plate 400 is tilted towards different directions at different time instances, generating a spherical rotational motion for the triangular movable plate 400 such that the incident laser beam strikes the biaxial scanning mirror at different angles (e.g. θ₁, θ₂) forming a substantially circular locus of incident points as shown in FIG. 4f. In this exemplary embodiment, the biaxial scanning is used; however, any mirror can be used in the triangular movable plate 400 of the present invention. When the laser from a laser source 450 is reflected by a mirror in the triangular movable plate 400, the pattern projected onto the screen 470 will substantially be a circle as shown in FIG. 4f.

In one exemplary embodiment, the phase difference between each of the two adjacent comb structures is 60 degree. If the amplitude of the signal voltages V₁, V₂, and V₃ is adjusted, the diameter of the circle projected onto the screen 470 will be changed. This helps to blur a single spot and reduces the speckling effect of the 2D image pattern projected on the screen 470. The signal voltage is set to be 40V and the driving frequency of the triangular movable plate 400 is set to be ranging from 200 Hz to 1600 Hz. For the triangular movable plate 400, the thickness of the torsional arm 435 is 20 μm, the quantity of the teeth is 200, the length of the teeth is 100 μm, and the width of the teeth is 5 μm and the gap between the teeth is 5 μm.

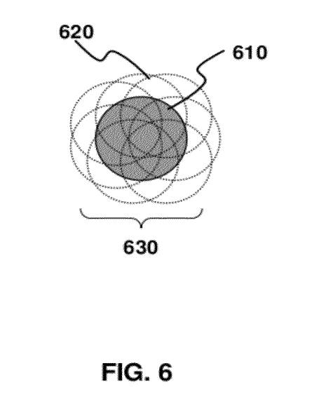

During operation, the movable plate 310 may vibrate in a combination of a vertical direction and a transverse direction. This vibrational motion is superposed on the deflection of the biaxial MEMS mirror device. The combination of different vibrations causes each incident laser beam hitting at periodically different incident angles of the biaxial MEMS mirror or, in another embodiment, at periodically different incident angles of the movable plate region in the absence of the biaxial MEMS mirror on the movable plate. Consequently, each laser beam is being reflected by the mirror 210 with distinct reflection angles temporally. And instead of being reflected as one single spot 610 onto a screen or, in other embodiments, another movable plate 310, a mirror or a biaxial MEMS mirror, each reflected laser beam generates a larger spot 630 which is an average of several original smaller spots 620 reflected onto different locations of the screen at different time as depicted in FIG. 6. The larger spot 630 is generated fast enough such that only the large spot 630 remains conceivable by an observer viewing the image on the screen. In this exemplary embodiment, the biaxial MEMS mirror is used; however, any mirror can be used in the movable plate 310 of the present invention.

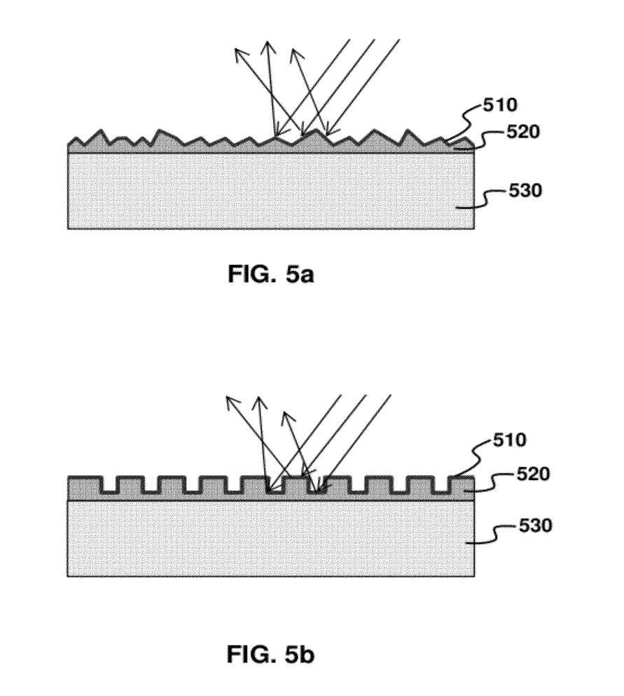

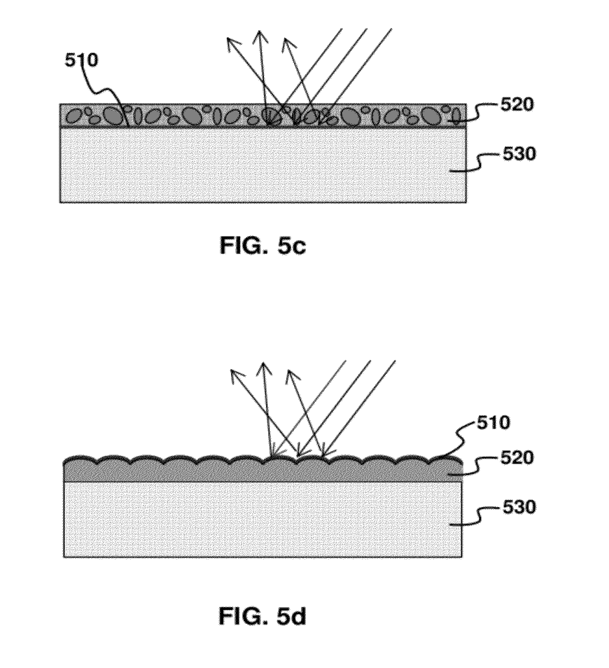

In one embodiment, a scattering layer is applied to the top of the mirror on the movable plate to increase the temporal distinctiveness in the reflection angles. Apart from merely coating a scattering layer on the mirror on the top of the movable plate 530, the scattering layer 520 has its surface roughened or polished in some embodiments and has a reflective coating 510 coated on the polished surface of the scattering layer 520 as depicted in FIG. 5a. Some examples of the reflective coating 510 include aluminum and gold. As an alternative of applying a scattering layer 520, the rough surface can be attained by polishing the mirror on the top of the movable plate 530 and subsequently applying a reflective coating 510 thereon to make the mirror on the top of the movable plate 530 reflective.

As depicted by FIG. 5b according another embodiment of the present invention, the scattering layer 520 is a patterned film of dielectric such as silicon oxide SiO₂ and silicon nitride Si₃N₄ has a reflective coating 510 coated on the patterned surface of the scattering layer 520. As an alternative of applying a scattering layer 520, the patterned surface can be attained by patterning the mirror on the top of the movable plate 530 and subsequently applying a reflective coating 510 thereon to make the top of the movable plate 530 reflective.

As depicted by FIG. 5c according another embodiment of the present invention, a reflective coating 510 is coated on the mirror on the top of the movable plate 530 and subsequently a scattering layer 520 of inhomogeneous phase-changing polymer such as liquid crystals is applied on the top of the reflective coating 510.

As depicted by FIG. 5d according another embodiment of the present invention, the scattering layer 520 of polymeric structure is applied to the mirror on the top of the movable plate 530 and has a reflective coating 510 coated on the polymeric structure of the scattering layer 520. Some examples of the polymeric structure include polydimethylsiloxane (PDMS), parylene polymeric material, SU-8 photoresist and various other photoresists.

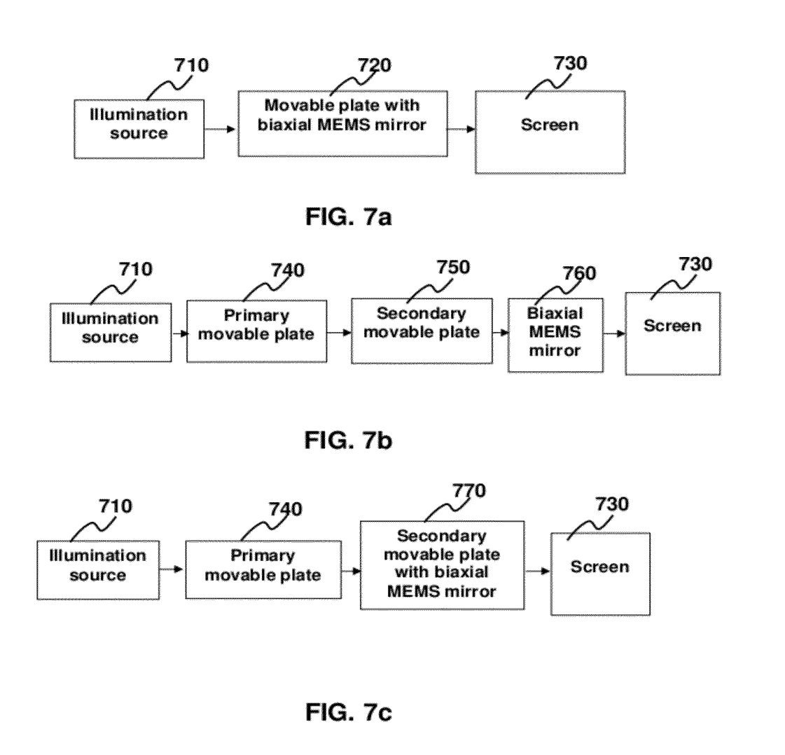

FIG. 7a shows a schematic block diagram of an optical system using a movable plate with biaxial MEMS device according to one embodiment of the present invention. The biaxial MEMS mirror is fabricated integrally in the movable plate and follows the various modes of vibration of the movable plate to reduce the speckle effect when reflecting the laser from an illumination source 710. The biaxial MEMS mirror on the movable plate 720 performs scanning of a laser with its rotations along two orthogonal axes to generate an image on a screen 730. The optical system may further include various components such as mirrors and lenses at various points of the path of the travelling laser. In this exemplary embodiment, the biaxial MEMS mirror is used; however, any mirror can be used in the movable plate of the present invention.

FIG. 7b shows a schematic block diagram of an optical system using one or more movable plates according to one embodiment of the present invention. To further increase the distinctiveness in reflective angles and the phase differences to the laser, one or more movable plates (without biaxial MEMS mirror devices) are provided such that a larger laser spot is reflected onto another movable plate which further generates a laser spot larger than before onto other surfaces. The first movable plate on the laser path is regarded as a primary movable plate 740 while the others are regarded as a secondary movable plate 750. Apart from other lenses and mirror in the optical system, a biaxial scanning MEMS mirror 760 is provided to reflect the laser in a scanning manner with its rotational motions along two substantially perpendicular axes. Consequently, the laser from an illumination source 710 reaches the screen 730 with reduced speckling effect.

FIG. 7c shows a schematic block diagram of an optical system using one or more movable plates and an independent biaxial MEMS mirror according to one embodiment of the present invention. Rather than having a standalone biaxial MEMS mirror for laser scanning, the biaxial MEMS mirror is fabricated within the movable plate 770. A laser beam from an illumination source 710 will be dispersed into a larger laser spot after the reflection by a primary movable plate 740 with its various vibrations in the vertical and transverse directions. The larger laser spot will be transmitted onto the biaxial MEMS mirror which reflects the same in a scanning manner to generate an image on a screen 730. The scanning by the biaxial MEMS mirror is coupled with the speckle reduction effect generated by the secondary movable plate because the biaxial MEMS mirror vibrates along with the secondary movable plate.

In one embodiment, the movable plate is implemented with a scanning mirror fabricated on it. An example for the design and fabrication of such a scanning mirror is described in Yick Chuen CHAN, et al, “Design and Fabrication of a MEMS Scanning Mirror with and without Comb Offet”, Proceedings of the 2010 5^{th} IEEE International Conference on Nano/Micro Engineered and Molecular Systems, Jan. 20-23 2010, Xiamen, China, which is incorporated herein by reference.

While particular embodiments of the present invention have been illustrated and described, it is understood that the invention is not limited to the precise construction depicted herein and that various modifications, changes, and variations are apparent from the foregoing description. Such modifications, changes, and variations are considered to be a part of the scope of the invention as set forth in the following claims.

What is claimed is:

1. A MEMS device for reducing speckle effect in a laser scanning display, comprising:
a movable plate configured to periodically vibrate in at least a horizontal plane with respect to the movable plate and/or at least a vertical plane with respect to the movable plate;
one or more first actuators configured to periodically move the movable plate in at least a first direction;
one or more second actuators configured to periodically move the movable plate in at least a second direction; and
a mirror integrally formed within the movable plate for reflecting an incident laser beam, such that the incident laser beam strikes the mirror at different angles according to a time of incidence causing the incident beam to be reflected and/or scattered with temporally varied properties, reducing the coherence of a reflected and/or scattered incident beam.

2. The MEMS device as claimed in claim 1, wherein:
the actuators are electrostatic combs.

3. The MEMS device as claimed in claim 1, wherein:
the actuators are magnetic actuators.

4. The MEMS device as claimed in claim 1, wherein:
the actuators are piezoelectric actuators.

5. The MEMS device as claimed in claim 1, wherein:
the movable plate has a triangular shape.

6. The MEMS device as claimed in claim 1, wherein:
the mirror is a biaxial scanning mirror.

7. The MEMS device as claimed in claim 5, wherein:
the first actuators move each side of the movable plate along the first direction at different time such that the incident laser beam strikes the mirror at different angles forming a substantially circular locus of the a reflected laser beam.

8. The MEMS device as claimed in claim 1, wherein:
one or more first combs are arranged along one outer edge of the movable plate and along an opposite outer edge of the movable plate.

9. The MEMS device as claimed in claim 1, wherein:
at least a portion of the mirror on the top of the movable plate is coated with a scattering layer.

10. The MEMS device as claimed in claim 3, wherein:
the surface of the scattering layer is coated with a reflective coating.

11. The MEMS device as claimed in claim 3, wherein:
the surface of the scattering layer is roughened.

12. The MEMS device as claimed in claim 3, wherein:
the scattering layer is a patterned film of dielectric.

13. The MEMS device as claimed in claim 3, wherein:
the scattering layer has a polymeric structure at least on the surface thereof.

14. The MEMS device as claimed in claim 3, wherein:
a reflective coating is provided between the top of the biaxial scanning mirror and the scattering layer.

15. The MEMS device as claimed in claim 9, wherein:
the scattering layer is made of inhomogeneous phase-changing polymer.

16. An optical system using the MEMS device as claimed in claim 1, further comprising:
an illumination source emitting one or more laser beams, one or more laser beams being transmitted onto the mirror of the MEMS device and reflected thereby in a scanning manner to generate an image on a display.

17. An optical system using the MEMS device as claimed in claim 1, further comprising:
an illumination source emitting one or more laser beams, one or more laser beams being transmitted onto a periodically vibrating movable plate of a MEMS device and reflected thereby;
at least one additional MEMS device, the MEMS device being the MEMS device of claim 1, positioned to receive and reflect the laser beams reflected from the periodically vibrating movable plate in a scanning manner to generate an image on a display.
